(19) United States
(12) Patent Application Publication
(10) Pub. No.: US 2013/0319726 A1
(43) Pub. Date: Dec. 5, 2013

(54) MULTI-CORE WIRE

(71) Applicants: Chin Teck Siong, Shah Alam (MY); Lai Cheng Law, Cheras (MY); Seok Khoon Lee, Seremban (MY)

(72) Inventors: Chin Teck Siong, Shah Alam (MY); Lai Cheng Law, Cheras (MY); Seok Khoon Lee, Seremban (MY)

(73) Assignee: FREESCALE SEMICONDUCTOR, INC, Austin, TX (US)

(21) Appl. No.: 13/483,069

(22) Filed: May 30, 2012

(51) Int. Cl. H01B 7/28; H01B 5/08

(52) U.S. Cl. 174/113 R; 174/128.1

(57) ABSTRACT

A wire that can be used in a wire bonding step in the assembly of a semiconductor device has a first conductive core, a second conductive core surrounding the first conductive core, and a third conductive core surrounding the first second conductive core. The first and third conductive cores are formed of a material such as Palladium and the second conductive core is formed of a material such as Copper. When the wire is bonded to a bonding pad of a semiconductor die, the first and third conductive cores melt over the free air ball (FAB)surface for the purpose of inhibiting intermetallic corrosion of the bonded ball.

### BACKGROUND OF THE INVENTION

The present invention relates generally to wires that conduct electrical current, and more particularly, to a multi-core wire used in a wire bonding step in the assembly or packaging of a semiconductor device.

Wires for conducting electrical current such as electrical signals, power and ground are well known. In the semiconductor industry, wires made of copper or gold typically are used to connect the bond pads on a semiconductor die to the lead fingers of a lead frame. However, gold wire is expensive and gold has been increasing in price. On the other hand, copper is not so expensive but it is harder to work with. For example, the interface between a copper bond wire and an aluminum bond pad can be subject to mechanical failure and increased potential contact resistance.

Further, the size of a semiconductor die has been decreasing and the processing capability increasing, so more inputs and outputs are needed for communication with the integrated circuit. Thus, bond pads are placed closer together (pitch) so thinner wires are needed. However, such thin wires must also have the strength to resist bending and breakage caused by external forces, such as when a mold compound flows over the wires during encapsulation. It is well known that the forces exerted on the wires by the mold compound can cause the wires to contact one another. This is known as wire sweep. The mold compound also can break brittle wires or weak bonds.

Thus, it would be advantageous to have a very thin yet strong wire. It would also be advantageous to have a wire that is less expensive in terms of the amount of copper or gold required to form the wires. It further would be advantageous to have a wire that is less subject to IMC (intermetallic compound) induced failure.

### BRIEF DESCRIPTION OF THE DRAWINGS

The invention, together with objects and advantages thereof, may best be understood by reference to the following description of the presently preferred embodiments together with the accompanying drawings. In the drawings, like numerals are used for like elements throughout.

FIG. 1 is greatly enlarged perspective view of a portion of a conventional bond wire;

FIG. 2 is greatly enlarged perspective view of a portion of a multi-core bond wire in accordance with an embodiment of the present invention;

FIG. 3 is a greatly enlarged side cross-sectional view of a wire in accordance with another embodiment of the present invention during a step in a wire bonding process; and

FIG. 4 is a greatly enlarged side cross-sectional view of the wire of FIG. 3 with a free air ball formed at a tip thereof.

Those of skill in the art will appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE INVENTION

The present invention is illustrated by way of example and is not limited by the accompanying figures, in which like references indicate similar elements.

In one embodiment, the present invention provides a multi-core wire for conducting an electrical current, including a first conductive core and a second conductive core that surrounds and is in contact with the first conductive core, where the first and second conductive cores are formed of different conductive metals. In one embodiment, a plating layer is formed over the second conductive core, the plating layer being of the same metal as the first conductive core.

In another embodiment, the present invention provides a wire used in a wire bonding operation during the assembly of a semiconductor device, the wire consisting essentially of a first conductive core and a second conductive core that surrounds and is in contact with the first conductive core. The first and second conductive cores both conduct electrical current, and during the wire bonding operation, when an end of the wire is attached to a bonding pad of the semiconductor device, the first conductive core melts onto the free air ball (FAB)surface and protects the bonded ball from intermetallic corrosion.

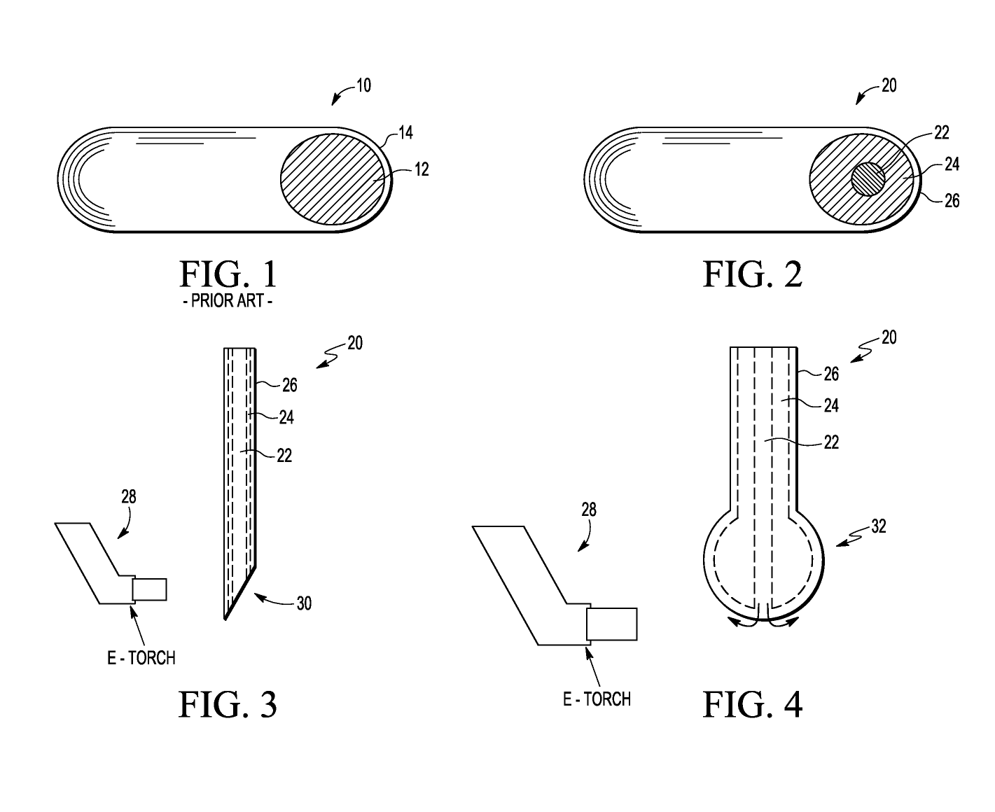

Referring now to FIG. 1, a conventional bond wire 10 used in a wire bonding process in which a semiconductor die bond pad is electrically connected to a lead of a lead frame or an electrical contact of a substrate. The bond wire 10 comprises a conductive metal core 12 such as Copper or Gold and a metal plating 14 such as Palladium. The metal plating 14 is provided to prevent Copper oxidation during the wire bonding process. However, the Pd layer 14 will migrate and concentrate on the neck of the wire 10 during the electronic flame off (EFO) step in the wire bonding process, which exposes the bare Cu and so the free air ball (FAB) formed is primarily Cu. The bonded ball without the Pd layer is vulnerable to corrosion induced by moisture and can thus cause product reliability issues. Careful EFO parameter optimization is required to ensure that the Pd layer covers the surface of the Cu FAB. However, the process parameters normally fall on a very narrow window range, which reduces robustness of the manufacturing process.

Referring now to FIG. 2, a multi-core wire 20 in accordance with an embodiment of the present invention is shown in perspective view with one end cut so that a cross-section of the wire 20 is visible. The wire 20 includes a first conductive core 22 and a second conductive core 24 that surrounds and is in contact with the first conductive core 22. The first and second conductive cores 22, 24 both conduct electrical current and preferably are formed of different metals. In one embodiment, the second conductive core comprises one of Gold, Copper, Aluminum and solder and the first conductive core comprises one of Nickel and Palladium. In a preferred embodiment of the present invention, the first conductive core 22 comprises Palladium and the second conductive core 24 comprises Copper.

The multi-core wire 20 also has layer 26 that surrounds the second conductive core 24. In a preferred embodiment, the layer 26 is a conductive metal that is plated (the layer 26 also is referred to as a third conductive core) or otherwise formed over the second conductive core 24, and in a preferred embodiment, the plating layer 26 comprises Palladium. Thus, in one embodiment, the present invention comprises a Palladium coated Copper wire that also has a Palladium core.

In one embodiment, the multi-core wire 20 is used for in a wire bonding process in which the wire 20 is used to electrically connect a lead of a lead frame or electrical contact pad of a substrate with a bonding pad of a semiconductor integrated circuit. Copper wire is currently very popular for wire bonding, however, as discussed above, it has drawbacks. The present invention essentially is an improved Copper wire used for wire bonding. Since the wire 20, as shown in FIG. 2, preferably does not include any insulative layers between the first and second cores 22, 24 and between the second core 24 and the plating layer 26, it may be said that the wire consists of or consists essentially of the first and second cores 22, 24 and the plating layer 26.

Referring to FIG. 3, the wire 20 is shown proximate to an electronic torch 28, which is used in a semiconductor wire bonding process to melt a tip 30 of the wire 20. As previously discussed, in a preferred embodiment the second core 24 comprises Cu that has a plating layer 26 of Pd and a first core 24 of Cu. FIG. 4 shows the formation of a FAB 32 by the heat from the torch 28. The arrows at the tip of the FAB 32 indicate the flow of Pd of the first core 22 around the end of the wire 20, where it merges with the Pd of the plating layer 26 so that when the wire 20 is attached to a bond pad of an integrated circuit, the Pd will cover the surface of the bonded ball.

In an alternative embodiment, the layer 26 may comprise a non-conductive coating that is formed over and around the second conductive core 24. In this alternative embodiment, the non-conductive coating comprises a polymer and its purpose is to prevent the first and second conductive cores 22, 24 from contact with the conductive cores of adjacent wires.

As can be seen, the first core 22 has a substantially uniform circular cross-section, as does the wire 20 overall. The particular diameter of the first core 22 will vary depending on the material from which the core is constructed, but may have a diameter that ranges from between about 3 um and 200 um. The second conductive core 24, which comprises a metal like Copper, may be plated or otherwise formed over the first conductive core 22 and has a diameter in a range of 13 um to about 250 um. The plating layer or third conductive core 26 may be plated over the second conductive core 24, by methods that are known in the art, and will have a thickness of between about 2 um to about 25 um, so that the wire 20 can range in thickness from about 15 um to about 275 um. In one embodiment, the first conductive core has a diameter of 7 um, the second conductive core 24 has a diameter of about 17 um, and the layer 26 has a thickness of about 3 um, such that the wire 20 has an overall thickness of 20 um.

The wire 20 is particularly suitable for conducting signals between an integrated circuit and external connection terminals therefor. For example, one end of the wire 20 may be bonded to a bonding pad of the integrated circuit and the other end of the wire 20 may be bonded to a lead finger of a lead frame or a bond pad of a substrate. For such uses, the wire 20 is connected to the integrated circuit bonding pad and the lead frame or substrate using commercially available wire bonding equipment. The heat or flame from the wire bonder melts the coating layer such that the coating layer will be bonded to either the IC bond pad, the lead finger or the substrate contact pad, as the case may be.

In the foregoing specification, the invention has been described with reference to specific embodiments. However, one of ordinary skill in the art will appreciate that various modifications and changes can be made without departing from the scope of the present invention as set forth in the claims below. For example, although the present invention is particularly well suited as a bond wire, it will be understood by those of skill in the art that the principles discussed herein may be appled to larger diameter wires for carrying larger currents. Accordingly, the specification and figures are to be regarded in an illustrative rather than restrictive sense, and all such modifications are intended to be included within the scope of the present invention.

Further, relative terms such as “front”, “back”, “top”, “bottom”, “over”, “under” and the like in the description and claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms “a” or “an”, as used herein, are defined as one or more than one. The term “plurality”, as used herein, is defined as two or more than two. The term another, as used herein, is defined as at least a second or more.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. A multi-core wire for conducting an electrical current, comprising:
a first conductive core formed of a first metal; and
a second conductive core, formed of a second metal different from the first metal, surrounding and in contact with the first conductive core, wherein the first and second conductive cores both conduct electrical current.

2. The multi-core wire of claim 1, wherein the first conductive core comprises Palladium.

3. The multi-core wire of claim 2, wherein the second conductive core comprises Copper.

4. The multi-core wire of claim 3, further comprising a conductive plating formed over the second conductive core.

5. The multi-core wire of claim 1, wherein the plating comprises Palladium.

6. The multi-core wire of claim 5, wherein the first conductive core and the conductive plating comprise Palladium and the second conductive core comprises Copper.

7. The multi-core wire of claim 1, further comprising a non-conductive coating surrounding the second conductive core.

8. The multi-core wire of claim 7, where the non-conductive coating comprises a polymer.

9. The multi-core wire of claim 1, wherein the second conductive core comprises a conductive metal plated over the first conductive core.

10. The multi-core wire of claim 9, wherein the conductive metal comprises one of Gold, Copper, Aluminum and solder.

11. The multi-core wire of claim 10, wherein the first conductive core comprises Nickel or Palladium.

12. The multi-core wire of claim 1, further comprising a third conductive core formed over and surround the second conductive core.

13. The multi-core wire of claim 12, wherein the first and third conductive cores comprise Palladium, and the second conductive core comprises Copper.

14. The wire of claim 13, further comprising a non-conductive coating surrounding the third conductive core.

15. The wire of claim 1, wherein the wire has an overall thickness of between about 15 um and 275 um.

16. A wire used in a wire bonding operation during the assembly of a semiconductor device, the wire consisting essentially of:
a first conductive core formed of a first metal; and
a second conductive core, formed of a second metal different from the first metal, surrounding the first conductive core, wherein the first and second conductive cores both conduct electrical current, and wherein during the wire bonding operation, when an end of the wire is attached to a bonding pad of the semiconductor device, the first conductive core melts onto the free air ball (FAB)surface and protects the bonded ball from intermetallic corrosion.

17. The wire of claim 16, further comprising a third conductive core formed over the second conductive core.

18. The wire of claim 17, wherein the first and third conductive cores comprise Palladium, and the second conductive core comprises Copper.

19. The wire of claim 17, wherein the wire has an overall thickness of between about 15 um and 275 um.
